(19) United States
(12) Patent Application Publication
(10) Pub. No.: US 2014/0012932 A1
(43) Pub. Date: Jan. 9, 2014

(54) INTEGRATING SOCIAL NETWORK POSTS

(71) Applicant: salesforce.com, inc., San Francisco, CA (US)

(72) Inventors: Samuel Sharaf, San Francisco, CA (US); Lauren Ingram, San Francisco, CA (US)

(21) Appl. No.: 13/929,611

(22) Filed: Jun. 27, 2013

Related U.S. Application Data
(60) Provisional application No. 61/667,852, filed on Jul. 3, 2012.

(51) Int. Cl. H04L 12/58

(52) U.S. Cl. CPC H04L 51/32
USPC 709/206

(57) ABSTRACT

A system and method for integrating social network posts is provided. The system, for example, may include a communication system and a processor communicatively coupled to the communication system. The processor may be configured to receive a message in a first social media network, determine when the message is designated as shareable on a second social media network, create, when the message is designated as shareable on a second social media network, reposting information enabling addressed users to repost the message on the second social media network, and transmit the message and reposting information to addressed users of the first social media network via the communication system.

### CROSS-REFERENCE TO RELATED APPLICATION(S)

This application claims the benefit of United States provisional patent application Ser. No. 61/667,852, filed Jul. 3, 2012, the entire content of which is incorporated by reference herein.

### TECHNICAL FIELD

The following relates social networking and more particularly to integrating social network posts.

### BACKGROUND

Social networking has become a widely used tool by both businesses and individuals to share messages and other information. Some businesses utilize in-house social networks to securely share messages to employees and allow employees to easily collaborate on projects in a secure manner. Other social networks, such as Facebook and Twitter, are useful tools for individuals and businesses to share updates with followers.

### DESCRIPTION OF THE DRAWING FIGURES

Exemplary embodiments will hereinafter be described in conjunction with the following drawing figures, wherein like numerals denote like elements, and

FIG. 1 is a block diagram of a social networking system, in accordance with an embodiment;

FIG. 2 is an exemplary social network interface in accordance with an embodiment;

FIG. 3 is another view of an exemplary social network interface in accordance with an embodiment; and

FIG. 4 is a flow chart illustrating an exemplary method for enabling a repost of a message from a first social network onto a second social network, in accordance with an embodiment.

### DETAILED DESCRIPTION

According to various exemplary embodiments, systems and methods are provided to integrate social network posts. As discussed above, businesses utilize in-house social networks to securely share messages to employees and allow employees to easily collaborate on projects in a secure manner. However, in some instances a business may want to share messages, posts, files, videos or pictures from a secure in-house social network with other social networks, such as Twitter, Facebook or the like. Accordingly, a system and method for controlling what content from the in-house social network can be shared is described herein.

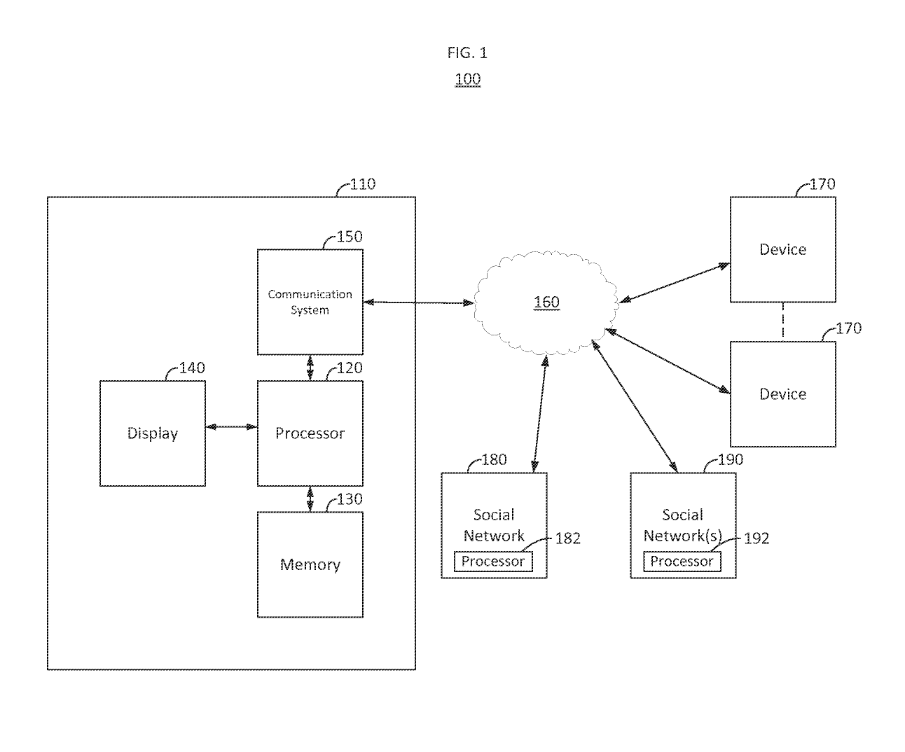

FIG. 1 is a block diagram of a social networking system 100, in accordance with an embodiment. The social networking system 100 includes at least one device 110. The device 110 may be any electronic device, including, but not limited to, a desktop computer, a laptop computer, a tablet, a cellular phone, a personal digital assistant, an electronic reader, an internet-connectable watch, or any other electronic device. The device 110 includes a processor 120. The processor may be, for example, a central processing unit (CPU), an application specific integrated circuit (ASIC), a microcontroller, a field programmable gate array (FPGA), a graphics processing unit (GPU), a physics processing unit (PPU), or any other logic device. The processor 120 is connected to a memory 130. In one embodiment, for example, the memory may be a non-transitory computer readable medium, such as a fixed local memory, such as a hard drive, or a removable local memory, such as a flash driver, a secure digital (SD) removable memory, a removable hard drive, or any other type of memory. In another embodiment, for example, the memory 130 may be a remote memory. The remote memory may be, for example, a cloud based memory that is implemented in a device or a system that is distinct from the device 100. In another embodiment, for example, the social networking system 100 may be part of a multi-tenant application system where the memory 130 is implemented in one or more servers that support a multi-tenant database. The memory 130 may store computer readable instructions for implementing a system for integrating social network posts, as discussed in further detail below.

The device 110 further includes a display 140 which is connected to the processor 120. The processor 120 can send instructions to the display 140 to display information to a user. The device further includes a communication system 150 connected to the processor 120. The communication system 150 connects the device to the internet or data connection 160 via one or more communication protocols. The communication system 150, for example, may be a cellular interface, a Wi-Fi interface, a local area network interface, a satellite interface, or any other data communication interface or combination thereof.

The device 110 is communicatively coupled to one or more other devices 170 via the internet or data connection 160 which allows the device 110 to post to a first social network 180 and control a subsequent distribution of the content of the post to a second social network 190, as discussed in further detail below. Each social network 180 or 190 is controlled by one or more servers having one or more processors 182 or 192, respectively. The second social network may be, for example, a non-business social media network, such as Twitter, Facebook, LinkedIn, Pintrest, MySpace, Google Plus, or any other social network.

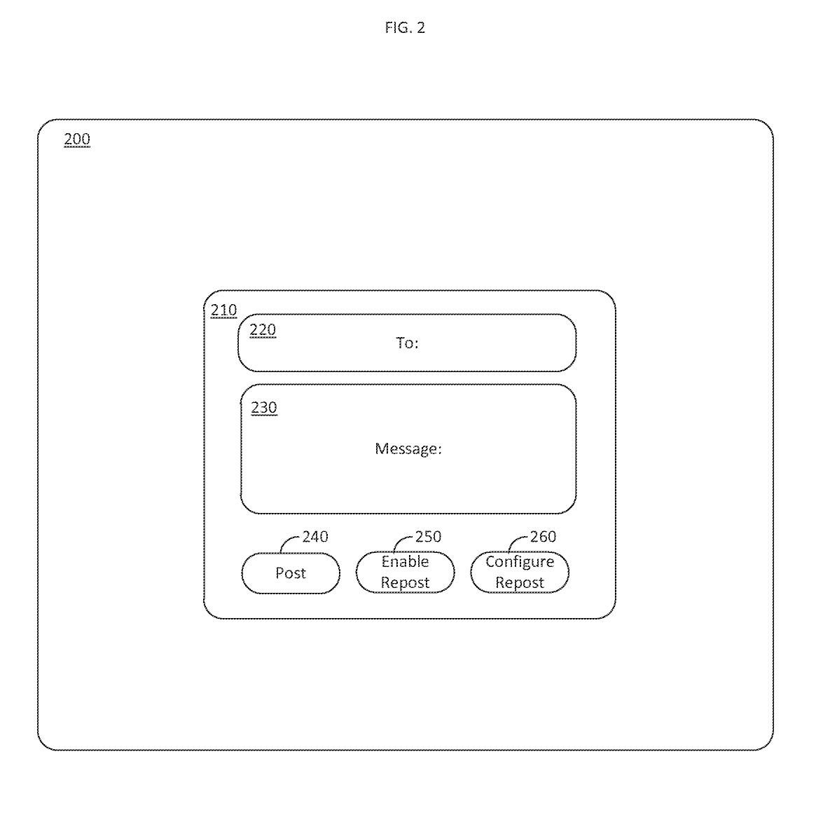

FIG. 2 is an exemplary social network interface 200 in accordance with an embodiment. The social network interface 200 may be displayed on a display, such as the display 140 illustrated in FIG. 1. The social network interface 200 is an interface for a first social network. In one embodiment, for example, the first social network may be an internal business social network, such as Chatter. Chatter provides sales representatives with a customer profile and account history, allows the user to manage marketing campaign spending and performance across a variety of channels from a single application, tracks opportunity-related data including milestones, decision makers, customer communications, and other information unique to the company's sales process. Automatic email reminders can be scheduled to keep teams up to date.

Furthermore, Chatter allows users to send messages to other users in the system, for example, users of devices 170 illustrated in FIG. 1. The social network interface 200 includes a message interface 210 to allow user to send messages to other users of the first social network 180. The messages may be, for example, sent directly to the device of another user (e.g., via a text message, or to a social networking application), may be posted to a social network page accessible by the other users, may be sent to email addresses associated with the users, or any combination thereof. In one embodiment, for example, a user may send a message through the message interface 210 to the social network 180 and the processor 182 of the social network may control the processing and distribution of the message.

The message interface 210 includes an address interface 220. The address interface 220 allows a user to select which users of the first social network will receive the message. The address interface 220 may allow a user to select individuals to receive the message, certain groups to receive the message or all users connected to the first user to receive the message. As discussed above, the first social network 180 may be an internal social network. Accordingly, the user may be able to select a group such as human resources groups, research and development groups, business groups, managements groups or any other employment group, combination or subset thereof. The messaging interface 210 further includes a workspace interface 230. The workspace interface 230 allows the user to add text, links, files, video, pictures, or any combination thereof to be the content of the message.

The messaging interface 210 further includes a post interface 240, an enable repost interface 250, and a configure repost interface 260. The post interface 240 posts the message to the addressed users. As discussed above, the method of posting the message may vary depending upon the social network.

The enable repost interface 250 enables recipients of the message to easily repost the message to a second social network. In one embodiment, for example, the repost interface 250 may be a check-box interface, however, one of ordinary skill in the art would recognize that there are a multitude of possible interfaces. The repost interface 250 may be defaulted to not allow the message to be reposted, forcing the user to actively interact with the repost interface 250 to enable other users to repost the message.

The configure repost interface 260 allows the users to select repost options for the users receiving the message. Repost options may include, but are not limited to, selecting the entirety or subset of the addressed users to receive permission to repost the message, selecting one or more of the second social networks for which the users can repost the message to, and manually specifying which portion or the entirety of the message as being sharable.

In another embodiment, for example, a processor, such as the processor 120 illustrated in FIG. 1, may automatically select a subset of the message as being shareable. The processor, for example, may only allow hyper text transfer protocol (HTTP) address to be sharable. In other embodiments, for example, the processor may automatically select a portion of the message enclosed by quote marks, parenthesis, slash marks, or another punctuation mark as being the shareable part of the message. One benefit of this embodiment, for example, is that a user can select which part of the message is sharable allowing the user to have both shareable and non-sharable parts of the message. Accordingly, if, for example, the user was the president of a company, the user could include a private message (i.e., “Congratulations on a great product release! Please share the message below and the link to this article with all your friends”) and a shareable message (i.e., CompanyX sold 500,000 units of ProductX in its first week of release. Here is a great review of the ProductX http://www.companyxproductxreview.com) in the same message.

In one embodiment, for example, the enable repost interface 250 and configure repost interface 260 may only be visible to a subset of the users of the first social network 180. Repost authorization information may be stored in a memory, such as the memory 130 illustrated in FIG. 1 or in a memory associated with the first social network 180 (not illustrated). Accordingly, a system administrator could allow certain users, such as the board of directors, the CEO of a company, a marketing team or other super users, permission of post sharable messages while other users may not. When a user of the first social network does not have permission to enable a message to be reposted to a second social network, the enable repost interface 250 and configure repost interface 260 may not be displayed on the user's message interface 210.

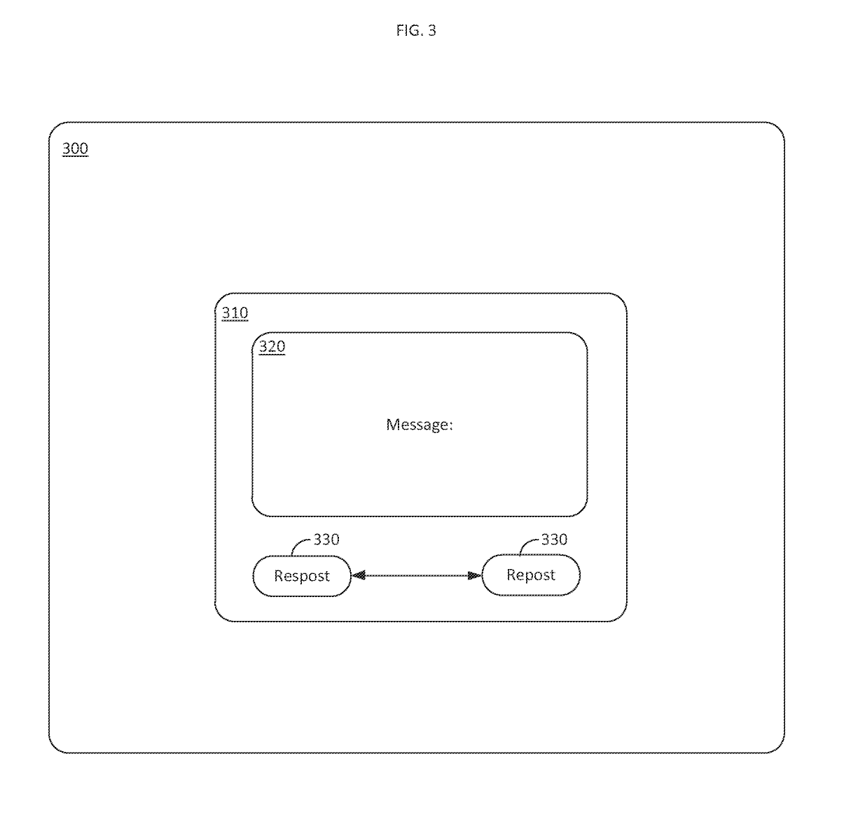

FIG. 3 is another view of an exemplary social network interface 300 on the first social network in accordance with an embodiment. The social network interface 300 includes a received message interface 310. The received message interface 310 includes a message 320 received from a user is who enabled the message to be reposted. As the message illustrated in FIG. 3 has permissions to be reposted, the social network interface 300 includes a repost interface 330. The repost interface 330 may be, for example, a virtual button or any other interface type. One of ordinary skill in the art would recognize that the repost interface 330 could be implemented in a variety of ways. When a user interacts with the repost interface 330, a processor, such as a processor (not illustrated) associated with a device 170 illustrated in FIG. 1, may retrieve login information for the second social network for the user from a memory and automatically post the message (or the part of the message which is designated as sharable) onto the second social network. If the user's login information is not stored in the memory, the processor may make a request to the user for the information. In another embodiment, for example, when the user interacts with the repost interface 330 a repost preview interface may be displayed. The repost preview interface may allow the user to view and/or edit the message before the message is reposted to the second social network.

As discussed above, the user who creates a message can select one or more social networks which the user is giving permission to repost the message to. In one embodiment, for example, a repost interface 330 may be displayed on the received message interface 310 for each social network which the user is giving permission to repost the message to. In another embodiment, for example, only a single repost interface 330 may be displayed on the received message interface 310 and a processor may automatically repost the message to any social network for which login information is stored in a memory.

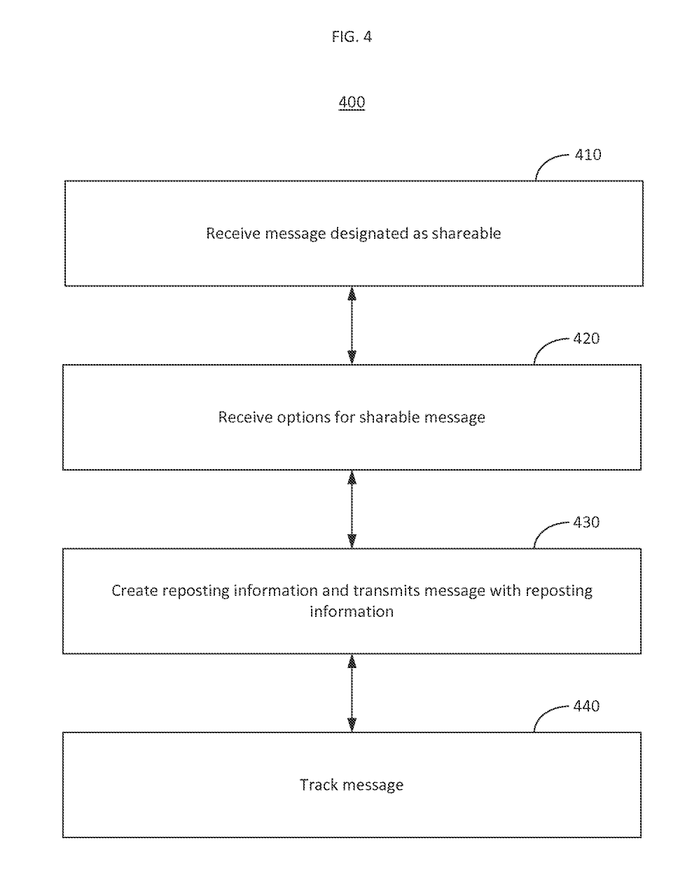

FIG. 4 is a flow chart 400 illustrating an exemplary method for enabling a repost of a message from a first social network onto a second social network, in accordance with an embodiment. A processor, such as the processor 182 illustrated in FIG. 1, first receives a message which is designated as being shareable and which is addressed to one or more users. (Step 410). The processor may also receive options for the shareable message. (Step 420). The options may include, which part of the message is shareable, which subset of the addressed users can share the message, and which secondary social networks the message can be reposted to. The processor then creates reposting information for each addressed user based upon any options which apply to the user and transmits the messages and the reposting information to the respective users. (Step 430). The reposting information, for example, controls which users can share the transmitted message, which portion of the transmitted message can be shared and which social networks the message or portion thereof can be shared to. In one embodiment, for example, a processor, such as the processor 120 illustrated in FIG. 1, may track the number of times the message has been reposted. (Step 440). The first social media network, for example, may be configured to transmit a signal to a device associated with the user who created the message each time the message is reposted. In another embodiment, for example, the first social network may include a homepage for each user. In this embodiment, for example, each time the user posts a shareable message an interface is displayed which tracks the number of times the message has been reposted. In this embodiment, for example, a processor associated with the first social network may receive a message each time the message is reposted. Further, on certain social media networks each time a message is reposted a uniform resource locator (URL) is created. The URL may be based upon the content of the message. Accordingly, a processor may track a social media network to determine each time a URL is created based upon the content of the message.

The term “exemplary” is used herein to represent one example, instance or illustration that may have any number of alternates. Any implementation described herein as “exemplary” should not necessarily be construed as preferred or advantageous over other implementations.

Although several exemplary embodiments have been presented in the foregoing description, it should be appreciated that a vast number of alternate but equivalent variations exist, and the examples presented herein are not intended to limit the scope, applicability, or configuration of the invention in any way. To the contrary, various changes may be made in the function and arrangement of the various features described herein without departing from the scope of the claims and their legal equivalents.

What is claimed is:

1. A system for integrating social network posts, comprising:
a processor, the processor configured to:
receive a message in a first social media network;
determine when the message is designated as shareable on a second social media network;
create, when the message is designated as shareable on a second social media network, reposting information enabling addressed users to repost the message on the second social media network; and
transmit the message and reposting information to addressed users of the first social media network.

2. The system according to claim 1, wherein the processor is further configured to:
receive information designating only a subset of the addressed users as having permission to repost the message; and
modify the reposting information to enable only the designated subset of the addressed users to repost the message on the second social media network.

3. The system according to claim 1, wherein the processor is further configured to:
receive information designating only a subset of the message as being shareable; and
modify the reposting information to enable only the subset of the message to be reposted on the second social media network.

4. The system according to claim 1, wherein the processor is further configured to:
receive information designating a plurality of second social media networks the message can be reposted on; and
modify the reposting information to enable the message to be reposted on the designated plurality of second social media networks.

5. The system according to claim 1, wherein the processor is further configured to track a number of times the message is reposted.

6. The system according to claim 5, wherein the processor is further configured to track the number of times the message is reposted based upon a created number of uniform resource locators.

7. The system according to claim 1, further comprising:
a memory communicatively coupled to the processor, the memory configured to store repost authorization information of each user on the first social media network,
wherein the processor is further configured to enable a respective user to designate the message is shareable based upon the repost authorization information associated with the respective user.

8. A method for integrating social network posts, comprising:
receiving, by a processor, a message in a first social media network;
determining, by the processor, when the message is designated as shareable on a second social media network;
creating, by the processor, when the message is designated as shareable on a second social media network, reposting information enabling addressed users to repost the message on the second social media network; and
transmitting, by a communication system, the message and reposting information to addressed users of the first social media network.

9. The method according to claim 8, further comprising:
receiving, by the processor, information designating only a subset of the addressed users as having permission to repost the message; and
modifying, by the processor, the reposting information to enable only the designated subset of the addressed users to repost the message on the second social media network.

10. The method according to claim 8, further comprising:
receiving, by the processor, information designating only a subset of the message as being shareable; and
modifying, by the processor, the reposting information to enable only the subset of the message to be reposted on the second social media network.

11. The method according to claim 8, further comprising:
receiving, by the processor, information designating a plurality of second social media networks the message can be reposted on; and
modifying, by the processor, the reposting information to enable the message to be reposted on the designated plurality of second social media networks.

12. The method according to claim 8, further comprising tracking, by the processor, a number of times the message is reposted.

13. The method according to claim 12, further comprising tracking the number of times the message is reposted based upon a created number of uniform resource locators.

14. The method according to claim 8, further comprising:
enabling, by the processor, a user to designate the message is shareable based upon repost authorization information associated with the user.

15. A computer-readable medium storing instructions which when executed by a processor cause the processor to:
receive a message in a first social media network;
determine when the message is designated as shareable on a second social media network;
create, when the message is designated as shareable on a second social media network, reposting information enabling addressed users to repost the message on the second social media network; and
transmit the message and reposting information to addressed users of the first social media network via a communication system.

16. The computer-readable medium according to claim 15, which when executed by the processor cause the processor to:
receive information designating only a subset of the addressed users as having permission to repost the message; and
modify the reposting information to enable only the designated subset of the addressed users to repost the message on the second social media network.

17. The computer-readable medium according to claim 15, which when executed by the processor cause the processor to:
receive information designating only a subset of the message as being shareable; and
modify the reposting information to enable only the subset of the message to be reposted on the second social media network.

18. The computer-readable medium according to claim 15, which when executed by the processor cause the processor to:
receive information designating a plurality of second social media networks the message can be reposted on; and
modify the reposting information to enable the message to be reposted on the designated plurality of second social media networks.

19. The computer-readable medium according to claim 15, which when executed by the processor cause the processor to track a number of times the message is reposted.

20. The computer-readable medium according to claim 15, which when executed by the processor cause the processor to enable a user to designate the message is shareable based upon repost authorization information associated with the user.
